(19) United States
(12) Patent Application Publication
(10) Pub. No.: US 2012/0032042 A1
(43) Pub. Date: Feb. 9, 2012

(54) SAFETY-HARNESS ATTACHMENT

(75) Inventors: Johnnie Kotrla, Katy, TX (US); Gary R. Driver, Katy, TX (US); Carter Erwin, Montgomery, TX (US)

(73) Assignee: CAMERON INTERNATIONAL CORPORATION, Houston, TX (US)

(21) Appl. No.: 13/256,615

(22) PCT Filed: Apr. 29, 2010
(86) PCT No.: PCT/US10/33031

§ 371 Date: Sep. 14, 2011

Related U.S. Application Data
(66) Substitute for application No. PCT/US2010/033031, filed on Apr. 29, 2010.
(60) Provisional application No. 61/174,851, filed on May 1, 2009.

(51) Int. Cl. E04G 21/32; F16M 13/02

(52) U.S. Cl. 248/205.1

(57) ABSTRACT

A safety-harness attachment for attaching a safety harness thereto.

### CROSS REFERENCE TO RELATED APPLICATIONS

This application claims priority to and benefit of PCT Patent Application No. PCT/US2010/033031, entitled “Safety-Harness Attachment”, filed on Apr. 29, 2010, which is herein incorporated by reference in its entirety, and which claims priority to and benefit of U.S. Provisional Patent Application No. 61/174,851, entitled “Safety-Harness Attachment”, filed on May 1, 2009, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

As will be appreciated, supplies of oil and natural gas have a profound effect on modern economies and civilizations. Devices and systems that depend on oil and natural gas are ubiquitous. For instance, oil and natural gas are used for fuel in a wide variety of vehicles, such as cars, airplanes, boats, and the like. Further, oil and natural gas are frequently used to heat homes during winter, to generate electricity, and to manufacture an astonishing array of everyday products.

In order to meet the demand for such natural resources, numerous companies invest significant amounts of time and money in searching for and extracting oil, natural gas, and other subterranean resources from the earth. Particularly, once a desired resource is discovered below the surface of the earth, drilling and production systems are often employed to access and extract the resource. These systems may be located onshore or offshore depending on the location of a desired resource.

Equipment to extract such resources can, in certain instance, be large in size. To fabricate and repair extraction equipment, it may be beneficial for appropriate personnel to perform activities on the equipment itself. However, this may place the personnel at relatively high locations on the equipment. Under certain workplace requirements, safety harness and restraints may by required for personnel working a given distance above the floor the equipment is on.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a perspective illustration of oilfield equipment, in accordance with one embodiment of the present technique;

FIG. 2 is a detail of the equipment of FIG. 1;

FIG. 3 is a perspective illustration of a safety-harness attachment, in accordance with one embodiment of the present technique;

FIGS. 4 and 5 are side views of the safety-harness attachment of FIG. 3; and

FIG. 6 is a top view of the safety-harness attachment of FIG. 3.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

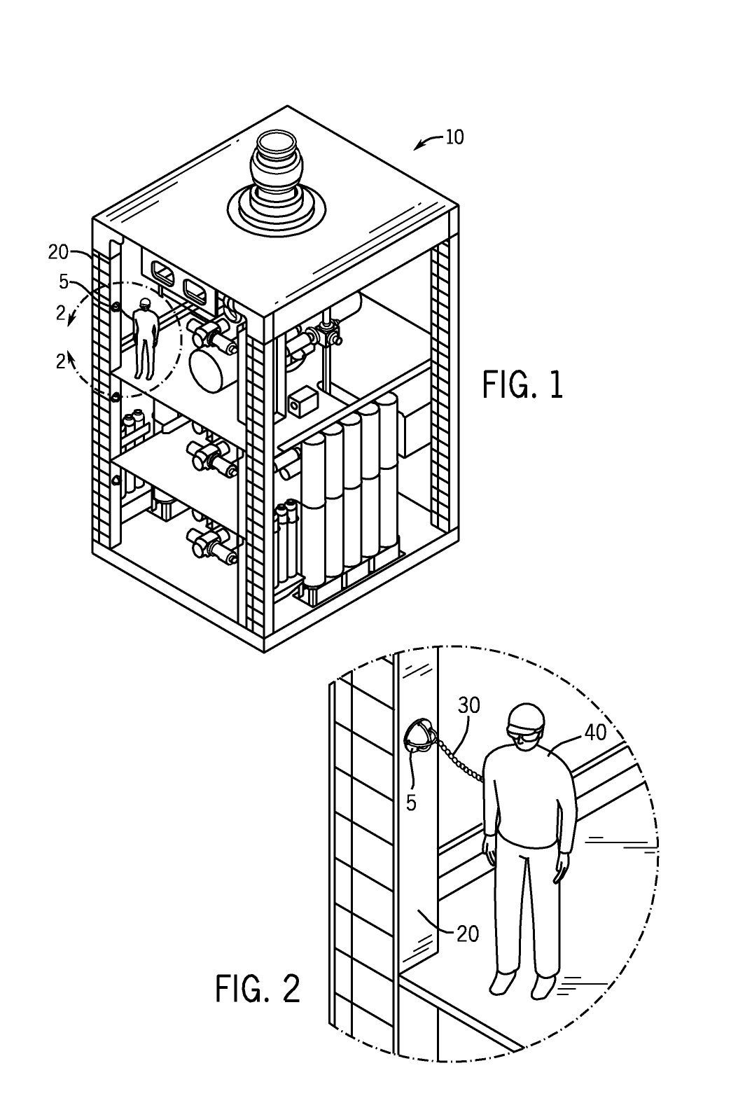

FIG. 1 illustrates an exemplary piece of equipment on which a safety-harness attachment 5 is provided. Specifically, the equipment shown is a subsea BOP (blowout-preventer) stack 10. However, the exemplary safety-harness attachment is applicable to any piece of equipment that could benefit with a feature to which a harness could be secured, whether that equipment is for the oilfield (e.g., a BOP, a Christmas tree, a valve assembly, a compressor, a manifold, a production assembly, among others) or other industrial equipment.

As illustrated in FIG. 2, the safety-harness attachment 5 may be mounted on a structural member 20 of the equipment 10. By way of example, the safety-harness attachment 5 may be welded onto the structural member 20, or secured using fastener, among other suitable techniques. The safety-harness attachment 5 may be mounted onto virtually any surface of the equipment 10, whether that surface is flat or curved, or vertical, horizontal or angular to the ground the equipment 10 is placed on. Moreover, the safety harness attachment 10 may be provided as an integral part of the equipment 5 or may be retrofitted onto existing equipment.

The safety-harness attachment 5 provides a dedicated feature to which a safety harness 30 may be attached, rather than being attached to an operating component of the equipment 10 that has a different purpose and may be damaged by misuse.

The illustrated safety harness 30 is a flexible device that provides freedom of movement to the technician 40, but mitigates against the technician from falling off of the equipment 10 by coupling the technician 40 to the equipment 10. The safety harness 30 may include various latching mechanisms to secure to the technician 40 and the safety harness attachment 5, respectively.

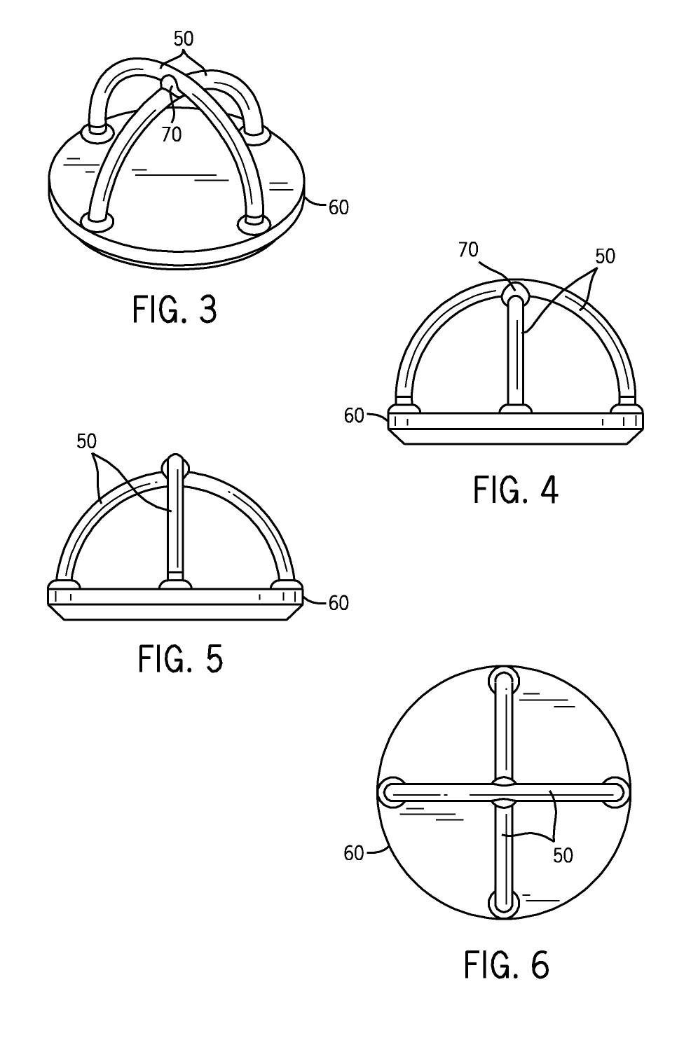

FIGS. 3-6 illustrate an exemplary safety-harness attachment 5. The illustrated safety-harness attachment includes two latch members 50 secured to a base 60. Although illustrated with two latch members 50, a safety-harness attachment 5 with any number of latch members 50 is envisaged. Moreover, the latch members 50 may be arcuate in shape, or angular, or a combination thereof.

The illustrated latch members 50 are attached to one another at a joint 70. The joint 70 provides added integrity to the safety-harness attachment 5, and also segregates the latch members 50 in four regions, to facilitate the attachment of multiple safety harnesses to a single safety-harness attachment 5.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An assembly, comprising:
a safety-harness attachment, comprising:
a base portion; and
at least one latching portion having a first end and a second end attached to the base portion;
wherein the safety-harness attachment is coupled to an oilfield device.

2. The assembly of claim 1, wherein the base portion comprises a circular plate.

3. The assembly of claim 2, wherein the first end of the at least one latching portion and the second end of the at least one latching portion are attached near an outer circumference of the circular plate.

4. The assembly of claim 3, wherein the at least one latch portion comprises a half-circular arc that extends from the first end to the second end.

5. The assembly of claim 1, wherein the safety-harness attachment comprises a first latching portion and a second latching portion.

6. The assembly of claim 5, wherein the first latching portion is attached to the second latching portion at a joint not on the base portion.

7. The assembly of claim 1, wherein the oilfield device comprises a blowout-preventer (BOP).

8. The assembly of claim 7, wherein the BOP is a subsea BOP.

9. The assembly of claim 1, wherein the oilfield device is a Christmas tree.

10. The assembly of claim 1, wherein the safety-harness attachment is dedicated for attaching a safety harness thereto.

11. A safety-harness attachment, comprising:
a base portion; and
at least one latching portion having a first end and a second end attached to the base portion.

12. The safety-harness attachment of claim 11, wherein the base portion comprises a circular plate.

13. The safety-harness attachment of claim 12, wherein the first end of the at least one latching portion and the second end of the at least one latching portion are attached near an outer circumference of the circular plate.

14. The safety-harness attachment of claim 13, wherein the at least one latch portion comprises a half-circular arc that extends from the first end to the second end.

15. The safety-harness attachment of claim 11, comprising a first latching portion and a second latching portion.

16. The safety-harness attachment of claim 15, wherein the first latching portion is attached to the second latching portion at a joint not on the base portion.

17. A system, comprising:
a safety-harness attachment having a circular base, and at least one latching member extending from a first end along the outer circumference of the circular base to a second end along the outer circumference of the circular base.

18. The system of claim 17, wherein the safety-harness attachment comprises at least two latching members that intersect each other at a joint that is not attached to the circular base.

19. The system of claim 18, wherein the latching members comprise half-circular arcs, and wherein the joint is generally located at apexes of the half-circular arcs.

20. The system of claim 19, wherein the safety-harness attachment is coupled to an oilfield device.
